(19) United States
(12) Patent Application Publication
(10) Pub. No.: US 2009/0286143 A1
(43) Pub. Date: Nov. 19, 2009

(54) BATTERY PACK

(76) Inventors: Wolf Matthias, Stuttgart (DE); Josef Baumgartner, Stuttgart (DE); Jan Breitenbach, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/194,212

(22) Filed: Aug. 19, 2008

(30) Foreign Application Priority Data
Sep. 6, 2007 (DE) 10 2007 042 404.5

(51) Int. Cl. H01M 10/48

(52) U.S. Cl. 429/90

(57) ABSTRACT

A battery pack according to the invention has a housing, at least one rechargeable battery cell, and at least one temperature sensor that is attachable in a thermally conductive fashion to the rechargeable cell. At least one clamping element is provided, which cooperates with the temperature sensor in such a way that it is possible to attach the temperature sensor to the rechargeable cell in a thermally conductive fashion.

### CROSS-REFERENCE TO RELATED APPLICATIONS

This application is based on German Patent Application No. 10 2007 042 404.5 filed on Sep. 6, 2007, upon which priority is claimed.

### BACKGROUND OF THE INVENTION

1. Field of the Invention

The invention relates to a battery pack, in particular a rechargeable battery pack for a hand-guided power tool.

2. Description of the Prior Art

In lieu of grid operation for the power supply, numerous band-guided power tools are equipped with rechargeable battery packs. The battery packs are composed of a plurality of electrically interconnected rechargeable cells that store electrical energy; these cells heat up both while being discharged during operation of the hand-guided power tool and while being charged with the aid of a charging unit. In the extreme case, a powerful heating can result in damage to the battery pack. It is therefore known to measure the temperature of the rechargeable cells of a battery pack in order to prevent thermal overloads. In the simplest case, when a predetermined maximum temperature is exceeded, the operation or the charging process can be interrupted in order to prevent overheating of the rechargeable cells.

It is known from the prior art to measure the temperature by attaching a temperature sensor, e.g. an NTC resistor, to one or more rechargeable cells by means of a thermally conductive adhesive tape. This requires an additional installation step because the temperature sensor has to be attached to a rechargeable cell with the adhesive tape. In addition, under some circumstances, the installation is not permanent because the adhesive tape can loosen over time, resulting in a contact of the temperature sensor with the rechargeable cell that is no longer optimal.

It is also known to place the temperature sensor loosely into an intermediate space between two adjacent rechargeable cells of a battery pack. This has the disadvantage of not assuring a reliable contacting of the temperature sensor with the rechargeable cell. This is particularly true for hand-guided power tools that vibrate powerfully during operation.

### ADVANTAGES AND SUMMARY OF THE INVENTION

The invention is based on a battery pack, in particular a rechargeable battery pack for a hand-guided power tool, having a housing and one or more rechargeable cells, and at least one temperature sensor that is attachable to the rechargeable cell in a thermally conductive fashion.

According to the invention, at least one clamping element is provided, which cooperates with the temperature sensor in such a way that it is possible to attach the temperature sensor to the rechargeable cell in a thermally conductive fashion. This is advantageous because it facilitates the assembly of the battery pack and simultaneously achieves a secure and durable thermal attachment. The temperature sensor no longer has to be attached to a rechargeable cell by means of an adhesive tape in a separate assembly step. Instead, it is possible for the temperature sensor to be fastened by being inserted, slid, or the like between the rechargeable cell and the clamping element. It is also possible for there to be two or more rechargeable cells. In this connection, the clamping element cooperates with the temperature sensor in such a way that it is possible for the temperature sensor to be attached to two or more rechargeable cells in a thermally conductive fashion. For example, the temperature sensor is clamped into the interstice between two cylindrical rechargeable cells situated resting against each other in the axial direction.

In a simple embodiment the clamping element is composed of a recess into which the temperature sensor is inserted or slid. The recess is situated in the region of a rechargeable cell so that the temperature sensor situated in the recess touches the rechargeable cell. Preferably, the recess is smaller than the temperature sensor so that the temperature sensor cannot be completely contained in the recess but instead protrudes out from the recess. As a result, during assembly, the temperature sensor is pressed against the rechargeable cell so that in the assembled state, the protruding part of the temperature sensor rests against a rechargeable cell.

The recess is preferably situated in the housing of the battery pack. This is particularly suitable when the housing snugly encompasses the rechargeable cells, for example by virtue of the housing forming a circumference wall that rests as snugly as possible against the shape of the outer contour of the cell group. Alternatively, however, the recess can also be embodied in another component of the battery pack. For example, electrically insulating spacers can be provided between adjacent rechargeable cells, which spacers hold opposing circumference surfaces of adjacent cells so that they are spaced slightly apart from each other in order, for example, to prevent short circuits due to vibrationally induced damages to the insulation of the cells. In addition, spacers can be placed in the interstices between respective groups of three adjacent cells arranged in a triangle or between respective groups of four adjacent cells arranged in a square. A recess for the temperature sensor can also be provided in spacers of this kind.

In an alternative embodiment, the clamping element is composed of an elastic element. It is particularly preferable for the clamping element to be embodied in the form of a resilient tab. A resilient tab or another elastic element can, for example, be formed onto the housing encompassing the rechargeable cells. The elastic element securely and durably clamps the temperature sensor to one or more rechargeable cells.

An elastic clamping element has the particular advantage that it is able to compensate for large dimensional tolerances of temperature sensors. For example, commercially available in NTC resistors have a diameter tolerance of approximately 1 mm. It is also possible for the elastic element to be provided in the form of a separate spring element that is not formed onto the housing or another component of the battery pack.

It is also possible to provide a combination of a recess and an elastic element. To accomplish this, an elastic element, for example in the form of a resilient tab, is provided in the recess and presses the temperature sensor situated in the recess against one or more rechargeable cells in the battery pack.

The thermal connection of the temperature sensor to the rechargeable cells can occur directly in that the temperature sensor directly touches one or more rechargeable cells. The thermal connection can, however, also occur indirectly in that a thermal conduction element is situated between the temperature sensor and the rechargeable cell, which element touches the temperature sensor on one side and the rechargeable cell on the other. The thermal conduction element can, for example, be embodied in the form of a thermal conduction paste, a thermally conductive elastomer, a thermally conductive adhesive, or another thermally conductive material or a combination of these materials.

The housing of the battery pack is composed in particular of plastic. Preferably, the housing is embodied as at least partially thermally conductive. To this end, it is possible to use a thermally conductive plastic in that thermally conductive material, e.g. metal, is admixed with a plastic that intrinsically has little or no thermal conductivity. As a result the heat generated during operation or during charging of the battery pack is distributed over a larger area. If there are a plurality of rechargeable cells in the battery pack, then a thermally conductive housing has the additional advantage that it provides for a thermal equalization between the individual rechargeable cells.

Preferably, the temperature sensor is a temperature-dependent resistor, e.g. an NTC resistor (negative temperature coefficient) or a PTC resistor (positive temperature coefficient), but other types of temperature sensors can also be used.

Another subject of the invention relates to a hand-guided power tool equipped with at least one battery pack according to the invention.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 is a perspective view of an embodiment of a battery pack according to the invention, equipped with a plurality of rechargeable cells;

FIG. 2 is an oblique view from above of a detail of the battery pack according to FIG. 1;

FIG. 3a is a cross section through the battery pack according to FIG. 1 along the line A-A in FIG. 2, without the temperature sensor;

FIG. 3b is a cross section through the battery pack according to FIG. 1 along the line A-A in FIG. 2, with the temperature sensor;

FIG. 4a is a cross section through an alternative embodiment of a battery pack, without the temperature sensor; and

FIG. 4b is a cross section through an alternative embodiment of a battery pack, with the temperature sensor.

### DESCRIPTION OF THE PREFERRED EMBODIMENTS

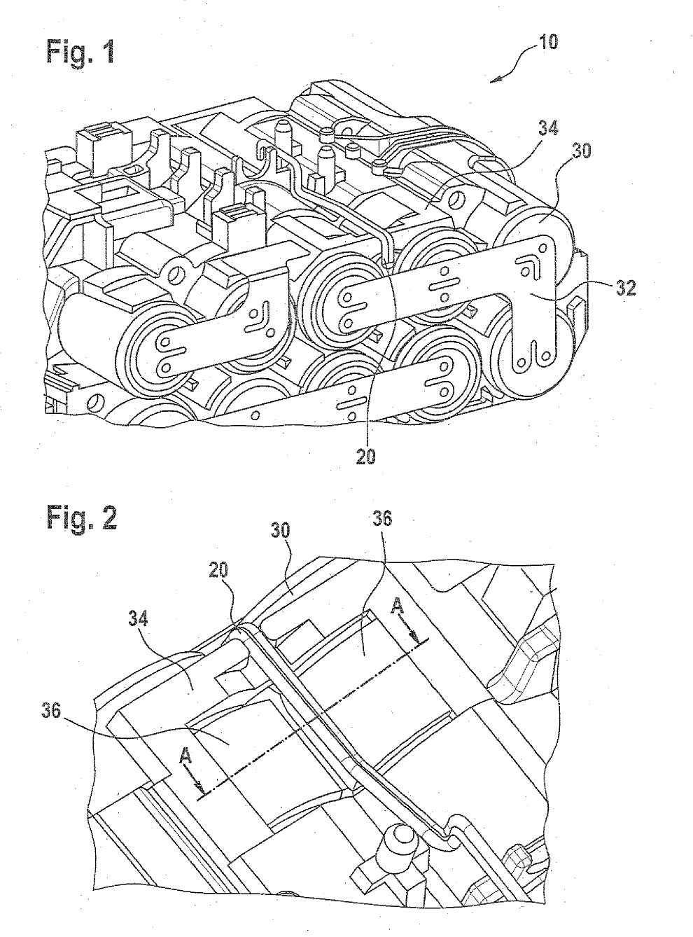

FIGS. 1 through 3 relate to a first embodiment of a battery pack according to the invention. FIG. 1 is a perspective view of a detail of a battery pack 10 with an NTC resistor as a temperature sensor 20. The battery pack 10 is suitable, for example, as a power supply for a hand-guided power tool (not shown). To this end, the battery pack 10 has a plurality of rechargeable cells 30 for storing electrical energy; the rechargeable cells 30 are electrically interconnected by means of cell connectors 32 so that the battery pack 10 produces the desired electrical voltage and capacitance. FIG. 1 shows two rows of five rechargeable cells 30 each, interconnected to form a battery pack 10.

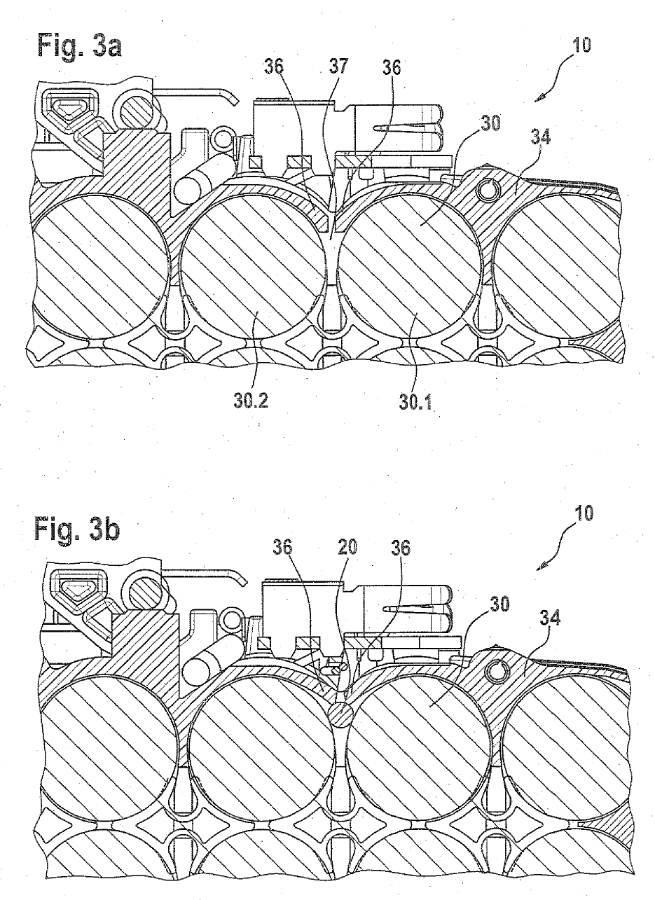

FIG. 3 shows that the rechargeable cells 30 are encompassed by a housing 34 in particular made of plastic. The housing 34 encompasses the rechargeable cells 30 as snugly as possible in that it forms a circumference wall that rests as snugly as possible against the shape of the outer contour of the cell group.

The embodiment according to FIGS. 1 through 3 shows a clamping element in the form of two resilient tabs 36. The tabs 36 are formed onto the housing 34 resting snugly against the rechargeable cells 30. They cooperate with the temperature sensor 20 so that the temperature sensor 20 is attached in a thermally conductive fashion to two adjacent rechargeable cells 30. The elasticity of the tabs 36 makes it possible to press the temperature sensor 20 against the rechargeable cells.

FIGS. 3a and b show a cross section through the battery pack 10 along the line AA in FIG. 2; FIG. 3a shows the battery pack without the temperature sensor and FIG. 3b shows it with the temperature sensor 20. Without the temperature sensor, the tabs 36 rests snugly against the outer circumference of the rechargeable cells 30.1 and 30.2. The tabs 36 extend into the interstice 37 between the two cylindrical rechargeable cells 30.1 and 30.2 resting against each other in the axial direction. If the temperature sensor 20 is inserted into the interstice 37, the elasticity of the tabs 36 causes it to be securely and durably clamped onto the rechargeable cells 30.1 and 30.2.

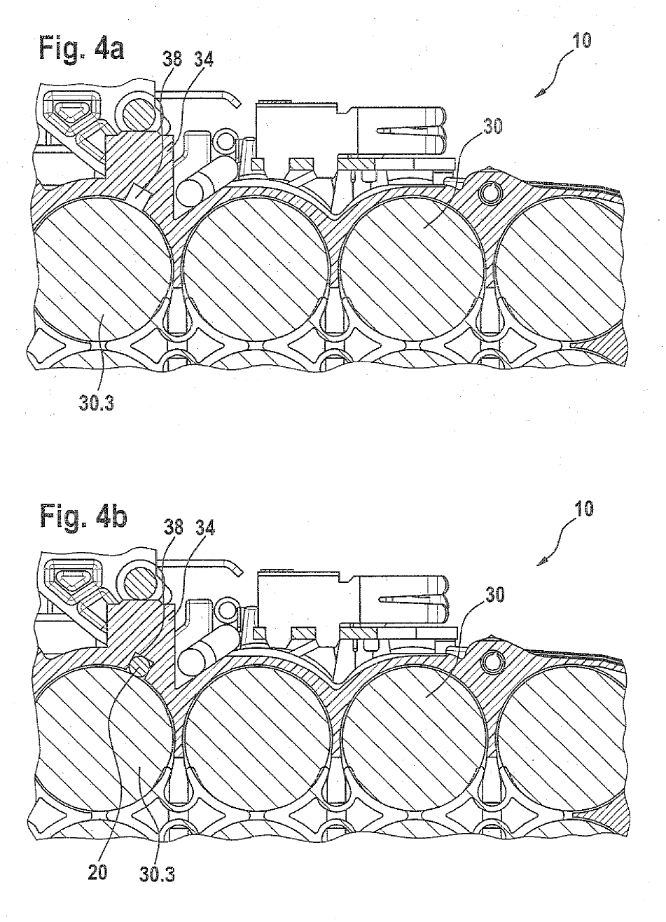

FIG. 4 relates to a second embodiment of a battery pack 10 according to the invention; FIG. 4a shows the battery pack without the temperature sensor and FIG. 4b shows it with the temperature sensor 20. In this case, the clamping element is composed of a recess 38 into which the temperature sensor 20 is inserted or slid. The recess 38 is embodied in the form of an axial groove in the housing 34 of the battery pack. Since the housing 34 rests snugly against the rechargeable cells 30 and the recess 38 is smaller than the temperature sensor 20, the recess 38 clamps the temperature sensor 20 securely and durably against the rechargeable cell 30.3. In this context, the recess 38 being smaller than the temperature sensor 20 means that the depth of the recess 38 is less than the diameter of the wire-shaped temperature sensor 20. If the temperature sensor 20 were inserted into the recess 38 without the rechargeable cell 30.3 having been inserted into the housing 34, then the temperature sensor 20 would therefore protrude out from the recess 38.

In addition, an elastic element can be provided in the recess 38, which element, in a fashion similar to the resilient tabs 36 of the first embodiment, presses the temperature sensor 20 in the direction of the rechargeable cell 30.3 (not shown).

The foregoing relates to preferred exemplary embodiments of the invention, it being understood that other variants and embodiments thereof are possible within the spirit and scope of the invention, the latter being defined by the appended claims.

We claim:

1. A battery pack comprising:
a housing;
at least one rechargeable cell;
at least one temperature sensor attached in a thermally conductive fashion to the rechargeable cell; and
at least one clamping element cooperating with the temperature sensor in such a way that the temperature sensor is attached to the rechargeable cell in a thermally conductive fashion.

2. The battery pack as recited in claim 1, wherein the clamping element is embodied as a recess.

3. The battery pack as recited in claim 2, wherein the recess is smaller than the temperature sensor.

4. The battery pack as recited in claim 1, wherein the clamping element is embodied as an elastic element.

5. The battery pack as recited in claim 2, wherein the clamping element is embodied as an elastic element.

6. The battery pack as recited in claim 3, wherein the clamping element is embodied as an elastic element.

7. The battery pack as recited in claim 4, wherein the elastic element has at least one resilient tab.

8. The battery pack as recited in claim 5, wherein the elastic element has at least one resilient tab.

9. The battery pack as recited in claim 6, wherein the elastic element has at least one resilient tab.

10. The battery pack as recited in claim 1, wherein the clamping element is embodied in the housing.

11. The battery pack as recited in claim 9, wherein the clamping element is embodied in the housing.

12. The battery pack as recited in claim 1, wherein at least two rechargeable cells are provided and the clamping element cooperates with the temperature sensor in such a way that the temperature sensor is attached to both of the rechargeable cells in a thermally conductive fashion.

13. The battery pack as recited in claim 11, wherein at least two rechargeable cells are provided and the clamping element cooperates with the temperature sensor in such a way that the temperature sensor is attached to both of the rechargeable cells in a thermally conductive fashion.

14. The battery pack as recited in claim 1, wherein the temperature sensor is attached to the rechargeable cell in a thermally conductive fashion by means of a thermal conduction element.

15. The battery pack as recited in claim 13, wherein the temperature sensor is attached to the rechargeable cell in a thermally conductive fashion by means of a thermal conduction element.

16. The battery pack as recited in claim 1, wherein the housing is embodied as at least partially thermally conductive.

17. The battery pack as recited in claim 15, wherein the housing is embodied as at least partially thermally conductive.

18. The battery pack as recited in claim 1, wherein the temperature sensor is a temperature-dependent resistor.

19. The battery pack as recited in claim 17, wherein the temperature sensor is a temperature-dependent resistor.

20. A hand-guided power tool having at least one battery pack as recited in claim 1.
